(19) United States
(12) Patent Application Publication
(10) Pub. No.: US 2015/0012658 A1
(43) Pub. Date: Jan. 8, 2015

(54) Virtual Network in a Content Delivery Network

(71) Applicant: Twin Technologies, Inc., Altamont, NY (US)

(72) Inventor: Benjamin Elmore, Altamont, NY (US)

(73) Assignee: TWIN TECHNOLOGIES, INC., Altamont, NY (US)

(21) Appl. No.: 14/325,328

(22) Filed: Jul. 7, 2014

Related U.S. Application Data
(60) Provisional application No. 61/843,415, filed on Jul. 7, 2013.
(60) Provisional application No. 61/843,414, filed on Jul. 7, 2013.

(51) Int. Cl. H04L 29/06

(52) U.S. Cl. CPC H04L 65/4061
USPC 709/226

(57) ABSTRACT

A Content Delivery Network comprises a virtual network overlaid on a network of geographically distributed content delivery nodes. The virtual network comprises a subset of the nodes selected to provide at least a minimum predetermined level of service to a requesting client. A virtual network controller resides on at least one virtual network node. The controller routes the requested media to at least one other virtual network node for formatting before delivering the suitably formatted media to the requesting client.

### CROSS-REFERENCE TO RELATED APPLICATIONS

This application claims benefit to U.S. Application No. 61/843,415 filed Jul. 7, 2013, and U.S. Application No. 61/843,414 filed Jul. 7, 2013, the entire contents of which are incorporated herein by reference.

### BACKGROUND OF THE INVENTION

I. Field of the Invention

The present invention relates to a system and a method for a content delivery network (CDN), and in particular, to systems and methods for managing resources for content distribution.

II. Description of the Related Art

Just as different varieties of content delivery services have evolved over time, several different network architectures have also evolved for deploying these services. These architectures range from fully centralized (e.g., using one or more centralized servers to provide content to all consumers) to fully distributed (e.g., multiple copies of content distributed on servers very close to the customer premises, at the “edge” of the distribution network)

Distributed computer systems are well-known in the prior art. One such distributed computer system is a CDN that is operated and managed by a service provider. The service provider typically provides the service on behalf of third parties. A distributed system of this type typically refers to a collection of autonomous computers linked by a network or networks, together with the software, systems, protocols and techniques designed to facilitate various services, such as content delivery or the support of out-sourced site infrastructure.

The CDN shifts the delivery of content from a centralized site to multiple highly distributed sites and overcomes many issues associated with network size, congestion, and failures. For example, a CDN employs a collection of content servers and associated control mechanisms to offload work from Website origin servers by delivering content on their behalf to end users. A well-managed CDN that serves some or all of the contents of a site's Web pages reduces the customer's infrastructure costs while enhancing the end-users' browsing experience.

In a CDN, multiple cache servers are deployed at different locations. Servers are connected in a certain network topology and cooperate to resolve requests sent from clients. More specifically, cache servers collaboratively make storage decisions and route content requests inside the cache hierarchy. This requires a carefully designed placement strategy for cached content, along with a specific request routing mechanism. In a conventional caching network that supports web content delivery, the perceived service quality can be improved with collaborative caching by minimizing the end-to-end latency of data packets. However, the problem becomes even more challenging when the collaborative caching mechanism is used to aid massive content delivery, such as streaming video.

In operation, the conventional CDN uses a request routing mechanism to locate a CDN content server close to the client to serve each request directed to the CDN, where the notion of “close” is based, in part, on evaluating results of network traffic tests. Since digital media objects may be found in a wide variety of forms, the distribution, processing, and routing of digital media objects requires different rules.

For example, a digital image object may have any of a number of image resolutions, color depths, compression methods, compression ratios, and file formats. A digital video object may be encoded using any of a number of codecs and compression standards. A digital audio file may have any number of bit rates and sampling frequencies and may similarly be encoded using any of a number of encoding and compression standards. The diversity of digital media standards may be represented by the format, which dictates how the media object is encoded, and the transport protocol, which determines how the media can be accessed. Due to the wide range of client device capabilities, the media format delivered to a client device is often not optimal for ingestion by the client device. Thus, digital media properties should be considered by the CDN to ensure that media delivered to each client is suitably formatted so it can be properly ingested and that unnecessarily large media files are not consuming network resources.

CDNs often receive content from any number of different production sources, syndicators, web-based services and other media sources. Often, each content source has its own set of techniques and formats for delivering new material. Media files may be delivered, for example, using any number of different transport techniques and channels. The media may be delivered in any number of different compressed and/or uncompressed formats that may be transcoded or otherwise converted before the content is made available for distribution to users. Furthermore, as users employ an increasing variety of client devices (e.g., mobile phones, tablets, laptops, video game players, and other portable devices), it can be advantageous to encode/transcode distributed content into any number of different distribution formats (e.g., different formats, and/or other files of different sizes, bit rates, frame rates, resolutions and/or other parameters) to accommodate a variety of viewers and viewing devices. Thus, the number of transcoding processes and other processes that may be performed on the content prior to distribution can be substantial.

### SUMMARY OF THE INVENTION

In accordance with some aspects of the disclosure, these and other problems are addressed by providing each edge node in a CDN with a virtual network connecting other nearby nodes that can complement the edge node's formatting and storage capabilities. For example, in the same manner a CDN enhances availability and delivery of content while reducing bandwidth costs and loads on the network backbone, aspects of the disclosure provide for cooperative content processing (including transcoding, formatting, and aggregation) at the edge nodes.

In some aspects, client requests for content are intercepted at an edge node. In one aspect, the client request is edited to modify the requested content format to ensure that the delivered content is suitable for ingestion by the destination client device. In another aspect, the client request is modified to request a content format that is more suitable for current network conditions, such as to match the content size or bandwidth to the client's available link bandwidth, to reduce local demands on the network, and/or to provide a predetermined quality of service to the client.

In some aspects of the disclosure, media content addressed to a client is intercepted at an edge node. The content may be transcoded or otherwise reformatted before being routed to the client device. In one aspect, the content format is modified to ensure that the delivered content is suitable for ingestion by the destination client device. In another aspect, the content format is modified to improve suitability for current network conditions, such as to match the content format to the client's available link bandwidth, to reduce local demands on the network, and/or to provide a predetermined quality of service to the client.

Furthermore, aspects of the disclosure account for network topology when selecting a server or process, as these aspects are configured to optimize performance and/or cost.

In one aspect of the disclosure, a CDN comprises a virtual network overlaid on a network of geographically distributed content delivery nodes. The virtual network comprises a subset of the nodes selected to provide at least a minimum predetermined level of service to a requesting client. A virtual network controller resides on at least one virtual network node. The controller routes the requested media to at least one other virtual network node for formatting before delivering the suitably formatted media to the requesting client.

In another aspect, a method comprises receiving a request for media from a client device in a CDN; selecting at least one CDN node for formatting the media, the at least one CDN node being selected to provide a low response time for delivering formatted media to the client device; and forwarding the request to the at least one CDN node.

In some aspects of the disclosure, a CDN comprises a content-delivery infrastructure, a request-routing mechanism, and a distribution mechanism. The content-delivery infrastructure comprises a network of geographically-distributed content delivery nodes that are arranged for efficient delivery of media content on behalf of third party content providers. The content delivery infrastructure usually comprises a set of “surrogate” origin servers (e.g., edge servers) that are located at strategic locations (e.g., Internet network access points, Internet Points of Presence, and the like) for delivering content to requesting end users. The request-routing mechanism allocates servers in the content delivery infrastructure to requesting clients in a way that, for web content delivery, minimizes a given client's response time and, for streaming media delivery, provides for the highest quality.

In one aspect of the disclosure, the request routing mechanism is configured to intercept and evaluate a client request en-route to a server. The request routing mechanism may modify the request, if necessary, to specify formatting that ensures the media content is suitable for ingestion at the client device, and/or improve network performance.

The distribution mechanism includes on-demand or push-based mechanisms that move content from the origin server to the surrogates. In another aspect of the invention, the distribution mechanism is configured for intercepting media en-route to a requesting client, and formatting or reformatting the media to provide a media format that is suitable for ingestion by the client device, and/or to improve network performance.

The request-routing mechanism and the distribution mechanism include methods, systems, and computer-readable media comprising program code for managing hierarchical data collection, analysis, and decision support for efficiently formatting and distributing media to a plurality of clients.

### BRIEF DESCRIPTION OF THE DRAWINGS

Aspects of the disclosure are illustrated in the figures of the accompanying drawings which are meant to be exemplary and not limiting, in which like references are intended to refer to like or corresponding parts, and wherein:

FIG. 1 is a network topology diagram of a hierarchical caching network according to one aspect of the invention;

FIG. 2 is a block diagram of an edge node in accordance with an aspect of the invention;

FIG. 3 is a flow diagram depicting steps in a method for establishing a virtual network in a CDN according to an aspect of the invention;

FIG. 4A is a flow diagram depicting a method for distributing media via a virtual network in a CDN according to an aspect of the invention;

FIG. 4B is a flow diagram depicting a method for distributing media via a virtual network in a CDN according to another aspect of the invention.

FIG. 5 is a flow diagram of a request routing method according to some aspects of the invention; and

FIG. 6 is a network topology diagram of a CDN according to an aspect of the invention.

### DETAILED DESCRIPTION

In the following description, reference is made to the accompanying drawings that form a part hereof, and in which is shown by way of illustration specific aspects in which the invention may be practiced. It is to be understood that other aspects and embodiments may be utilized, and structural changes may be made without departing from the scope of the invention.

As used herein, a media object includes, without limitation, an audio file (such as, e.g., an MP3 (Motion Picture Experts Group-1 Layer 3) file and a RealNetworks, Inc. Real format file), a video file (such as an MPEG file), an image file (such as, e.g., a BMP (bitmap) file or JPEG (Joint Photographic Experts) file) and any other software or data file or object.

A parent server (or parent site or parent server site) may comprise one parent server or a cluster of parent servers. Likewise, an edge server (or an edge site or edge server site) may comprise one edge server or a cluster of edge servers, and an origin server (or an origin server site or origin site) may comprise one origin server or a cluster of origin servers. The CDN may be configured such that servers in a cluster share a common storage. However, aspects of the invention may use a variety of different network configurations.

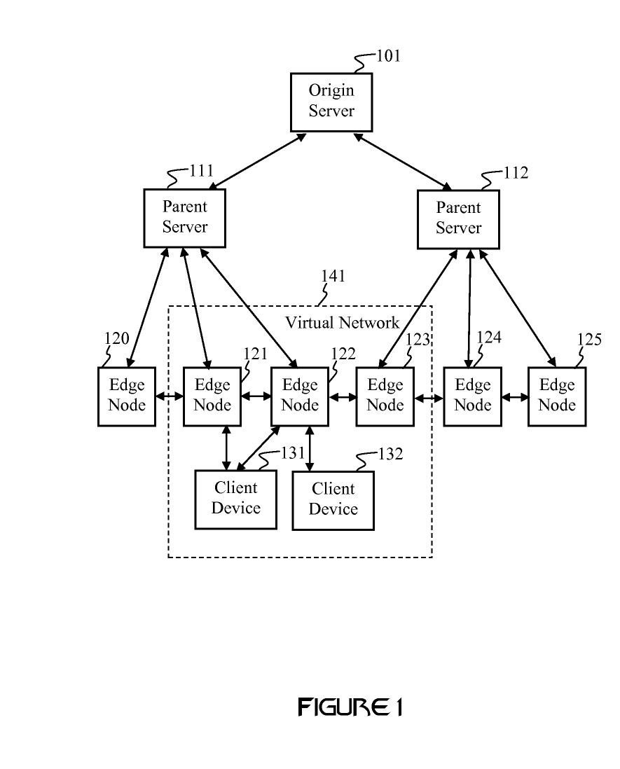

FIG. 1 is a network topology diagram of a hierarchical caching network. A top-level cache comprises one or more origin servers, such as origin server 101. A mid-level cache comprises multiple parent servers, such as servers 111 and 112 communicatively coupled to the origin server 101. A bottom-level cache comprises multiple edge servers, such as edge nodes 120-125. Typically, each edge node 120-125 is communicatively coupled to at least one of the parent servers 111 and 112. Each edge node 120-125 typically serves one or more clients. For example, Client 131 may be served by edge nodes 121 and/or 122, and client 132 is served by edge node 122.

In accordance with one aspect of the disclosure, one of the edge nodes 122 establishes a virtual network 141 with other edge nodes (e.g., nodes 121 and 123) for serving its clients 131 and 132. Thus, the clients may be regarded as part of the virtual network 141. Furthermore, one or more of the parent servers 111 and 112 and/or origin servers (e.g., origin server 101) may be part of the virtual network 141. As used herein, content delivery nodes refers to edge nodes, and may also include parent server nodes and/or origin server nodes.

A virtual network, as used herein, is a group of virtual nodes connected together by a set of virtual links to form a virtual network topology. The underlying physical topology (e.g., parent servers and edge servers) from the infrastructure provider distributes the necessary resources to the logical network. Physical nodes (e.g., parent server nodes and edge server nodes) host virtual nodes while physical links provide network infrastructures and resources for virtual links.

The CDN shown in FIG. 1 is a network of geographically distributed content delivery nodes that are arranged for efficient delivery of content on behalf of third party content providers. A request from a client device for given content is directed to a “best” replica, where “best” usually means that the requested media is served to the client quickly compared to the time it would take to fetch it from the content provider's origin server.

In one aspect of the disclosure, the virtual network 141 improves the efficiency of the CDN by delivering suitably formatted media to each client 131 and 132. As used herein, “suitably formatted” refers to media formatting that does not require the client 131 and/or 132 to format, transcode, or otherwise reformat the received media before it is ingested. Thus, in this aspect, the edge node 122 establishes the virtual network 141 to include other server resources and/or formatting resources to serve suitably formatted media to its clients 131 and 132 (i.e., clients from which node 122 receives requests for media). These resources may include servers storing formatted media and/or nodes having specific transcoding/formatting capabilities. To be included in the virtual network 141, the aforementioned resources are selected to complement the media stored in, and/or the media formatting capabilities of the virtual network controller node 122. Such resources are referred to as complementary formatting resources. By providing node 122 with access to a full array of media formats for popular content and/or providing a full array of media formatting capabilities via the virtual network, the node 122 is capable of serving a full array of media of different formats to requesting clients 131 and 132.

The node 122 may serve suitably formatted media either directly or via other edge nodes in the virtual network 141. Furthermore, the aforementioned resources are selected to provide “best” delivery, where “best” usually means that the requested media is served to the client quickly. In some aspects of the disclosure, the resources are selected based on load-balancing algorithms that may serve to reduce network congestion. Thus, queue backlogs at the servers may be considered when selecting which nodes to include in the virtual network 141. The virtual network 141 may be reconfigured periodically or depending on changing network conditions, such as for load balancing and/or optimizing delivery of requested media.

Typically, a CDN is implemented as a combination of a content delivery infrastructure, a request-routing mechanism, and a distribution infrastructure. The content delivery infrastructure usually comprises a set of surrogate servers that are located at strategic locations (e.g., Internet network access points, Internet Points of Presence, and the like) for delivering copies of content to requesting clients. The request-routing mechanism allocates servers in the content delivery infrastructure to requesting clients in a way that, for web content delivery, minimizes a given client's response time and, for streaming media delivery, provides for the highest quality. The distribution infrastructure consists of on-demand or push-based mechanisms that move content from the origin server to the surrogates. In addition, the CDN infrastructure typically includes network monitoring systems to continuously monitor the state and health of servers and the networks they are in.

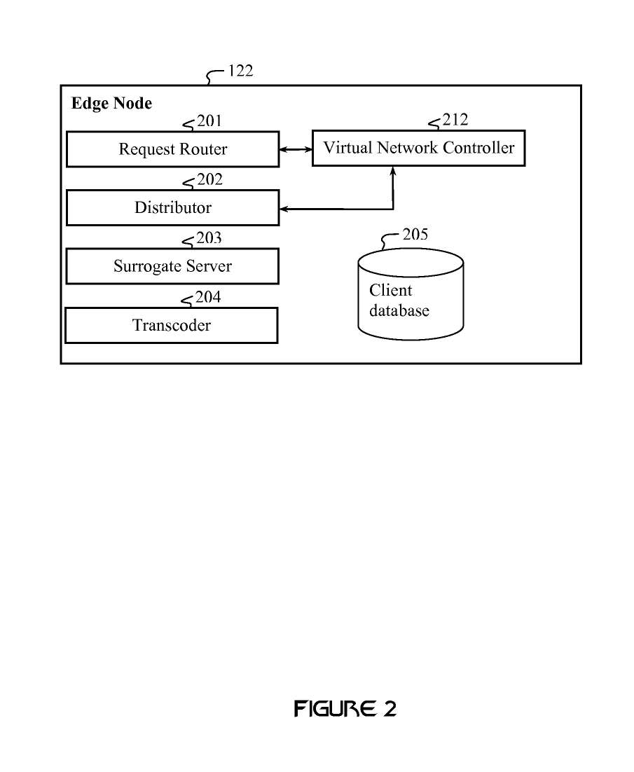

FIG. 2 is a block diagram of an edge node in accordance with an aspect of the invention. The edge node 122 comprises a request router 201, a distributor 202, a surrogate server 203, and a transcoder 204. The edge node 122 further comprises a virtual network controller 212 coupled to at least the request router 201 and the distributor 202. The edge node 122 may also include a client database 205 residing on a computer-readable memory. In accordance with one aspect of the invention, the virtual network controller 212 interacts with the request router 201 to provide “best” delivery (or at least a predetermined level of service) of suitably formatted media to a requesting client.

In one aspect of the invention, a CDN comprises a virtual network (e.g., virtual network 141) overlaid on a network of geographically distributed content delivery nodes. The virtual network 141 comprises a subset of the nodes (e.g., nodes 121-123), which are selected to provide at least a minimum predetermined level of service to a requesting client (e.g., client 131 and/or 132).

In a first aspect, a virtual network controller (e.g., virtual network controller 212) residing on at least one virtual network node (e.g., node 122) is configured for routing media to at least one other virtual network node (e.g., node 121 and/or node 123) for content formatting (e.g., transcoding and/or other media formatting to produce suitably formatted media) before delivering the media to the requesting client. The at least one other virtual network node 121 and/or 123 is typically selected to minimize delivery time to the requesting client 131 and/or 132.

In a second aspect of the invention, the virtual network controller 212 instructs the request router 201 to route a request for media to a “best” node (e.g., node 121 or 123) configured for delivering suitably formatted media to the requesting client 131 and/or 132. The best node 121 and/or 123 may have the requested media already suitably formatted and stored in memory. Alternatively, the “best” node 121 and/or 123 may be configured for suitably formatting raw media or converting less-than-optimal (or unsuitably) formatted media. Selection of the “best” node may be based on the aggregate of the time it takes a node to suitably format the media and the time it takes to deliver the suitably formatted media to the requesting client 131 and/or 132).

In the above-mentioned first and second aspects, the edge node 122 may employ device information about the requesting client 131 and/or 132 to determine a suitable format for the delivered media. For example, information about the client device (e.g., its presentation capabilities, operating system, software, and/or link bandwidth) may be used to determine an appropriate or preferred format for the requested media.

The content may need to be transcoded into a suitable format based on the type of client device receiving the content. Such transcoding may produce formats for consumption by legacy set-top boxes, formats for use on personal computers, as well as formats for use by smart phones and other portable media devices. Alternative formats may be employed, the foregoing being merely illustrative.

Other factors, such as network congestion, network outages, and queue backlogs may be used to determine a suitable format, such as to improve network performance and/or ensure a predetermined quality of service to the user.

In one aspect of the invention, the edge node 122 obtains client device information from the client database 205, which may comprise client device information indexed by a client ID. In another aspect of the invention, the edge node reads client device information transmitted in the request for media. In one example wherein a request for media may include client device information, a requesting client device is not the destination device that renders the requested media. Therefore, the requesting client may identify the destination device in its request such that the delivered media is suitably formatted for the destination device.

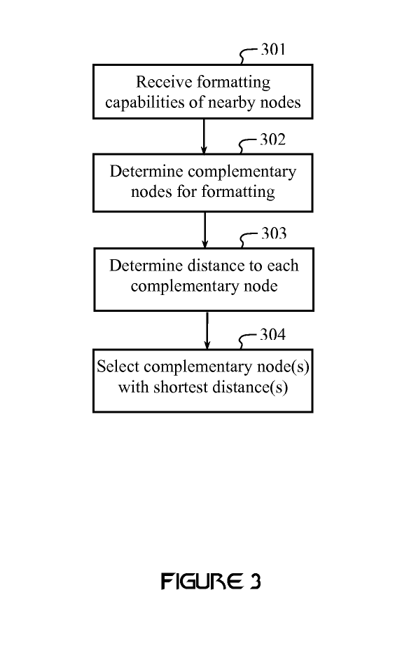

FIG. 3 is a flow diagram depicting steps in a method for establishing a virtual network in a CDN according to an aspect of the invention. An edge node, such as node 122, acquires information about the formatting capabilities of other CDN nodes 301. The edge node 122 determines which of the other nodes provide complementary formatting capabilities (i.e., formatting that cannot be performed by node 122) 302. The edge node 122 determines the distance to each complementary node 303. The edge node 122 selects the complementary node(s) having the shortest distance(s) 304. The edge node 122 includes the selected nodes in its virtual network.

In step 301, the edge node 122 may select a predetermined set of nearby nodes from which to acquire the formatting capabilities. In one aspect, the edge node 122 queries the nearby nodes for their formatting capabilities. The edge node 122 may query nearby nodes for specific formatting capabilities, such as complementary formatting capabilities. In some aspects, the nodes maintain a database of each other's formatting capabilities. The formatting capabilities of the other nodes may comprise not only each node's ability to provide formatting, but also the availability of the node to provide such formatting, which may be determined by queue backlogs, network congestion, and the like.

In Step 302, the edge node 122 identifies which other node(s) complement its formatting capabilities. In one aspect, the node 122 determines which formats are required based on the types (and, optionally, the number) of client devices it serves. In some aspects, the node 122 may determine required formats based on the types (and, optionally, the numbers) of client devices served by nearby nodes (e.g., nodes 121 and 123). In some aspects, steps 301 and 302 may be combined. For example, steps 301 and 302 may comprise querying nearby nodes about whether they can provide complementary formatting. A node that is capable of providing complementary formatting is referred to as a complementary node.

In Step 303, the distance to a complementary node may comprise any combination of a set of measured or estimated latencies, the set comprising the time it takes to deliver data between the node 122 and the complementary node, the time it takes the complementary node to format media, the time it takes the complementary node to retrieve formatted media, and the time it takes the complementary node to deliver media directly to at least one of the client devices served by the node 122.

In Step 304, more than one node that provides the same complementary formatting service may be selected. Such redundancy may be employed to handle varying demand volumes and other variable network conditions without requiring the node 122 to reconfigure its virtual network.

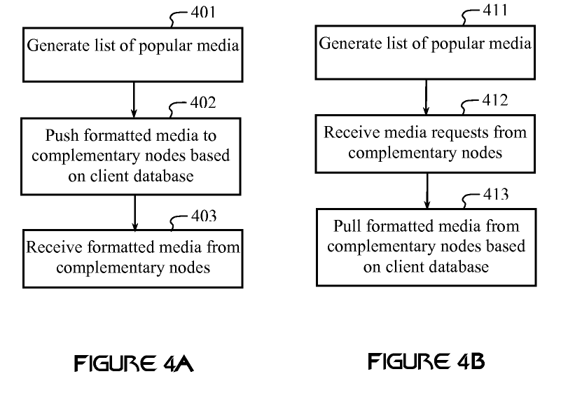

FIG. 4A is a flow diagram depicting steps in a method for distributing media via a virtual network in a CDN. A distribution system, such as one or more distributors 202, generates a list of popular media 401. Upon receiving the list, the distributor 202 pushes appropriately formatted media to complementary nodes 402. The distributor 202 may also receive formatted media from other nodes, such as the edge node's 122 complementary nodes.

In Step 401, the list may be generated in response to requests for media from clients. Thus the list of popular media may comprise media content that is currently in high demand. Similarly, the list may be generated in anticipation of future client requests for specific media.

In some aspects of the invention, the method shown in FIG. 4A is performed by at least one node, such as the node 122. In these aspects, a virtual network is established, which provides links to complementary nodes. Node 122 is capable of formatting media according to a first set of formats. At least a second node (e.g., node 123) is capable of formatting media according to a second set of formats. If node 123 is able to generate a format that node 122 is unable to produce, then node 122 may select node 123 as a complementary node in its virtual network. Similarly, node 123 may select node 122 as a virtual node in its virtual network if node 122 can complement node 123's formatting capability.

In Step 402, the distributor 202 determines that node 123 requires media formatted according to a particular format. If node 122 is capable of generating the required formatted media, it pushes that formatted media to node 123. If the node 122 is unable to produce the required format, it may receive the required formatted media from other nodes and then push it to node 123. Alternatively, node 122 may instruct other nodes in its virtual network to push the required formatted media to node 123.

In one aspect of the invention, node 122 may determine the required formats based on the client devices that it may serve. For example, the distributor may pull data about currently served client devices from the client database 205 before determining which media formats should be employed.

In Step 403, the node 122 receives formatted media from its complementary nodes. For example, if node 122 is unable to produce media having a second format type, it receives media having the second format type from at least one of its complementary nodes (e.g., node 123). In one aspect, the complementary node 123 determines that devices node 122 serves may require media having the second format type, so it pushes 402 the formatted media to node 122.

FIG. 4B is a flow diagram depicting steps in of an alternative method for distributing media via a virtual network in a CDN. A distribution system, such as one or more distributors 202, generates a list of popular media 411. Step 411 is identical to Step 401. The distributor 202 may receive requests 412 for formatted media from other nodes, such as the edge node's 122 complementary nodes. Upon receiving the list, the distributor 202 pulls appropriately formatted media from its complementary nodes 413.

In Step 412, the distributor 202 responds to requests from node 122's complementary nodes. If the node 122 is capable of generating the media with the requested formats, or if node 122 is storing the requested formatted media, the distributor transmits the requested formatted media to the requesting nodes. Alternatively, node 122 may relay the requests to other nodes in the virtual network. In response to the relayed request, another node may either send the requested formatted media directly to the requesting node or it may deliver the media to node 122, which then forwards the media to the requesting node.

In Step 413, the distributor 202 pulls formatted media from one or more of its complementary nodes. For example, node 122 determines which media formats it needs to service its clients. The required formats may be determined from the client database 205. The distributor 202 communicates with the distributor(s) on the complementary node(s) to pull complementary formatted media (e.g., media having a format that node 122 is unable to produce and is not currently stored on node 122).

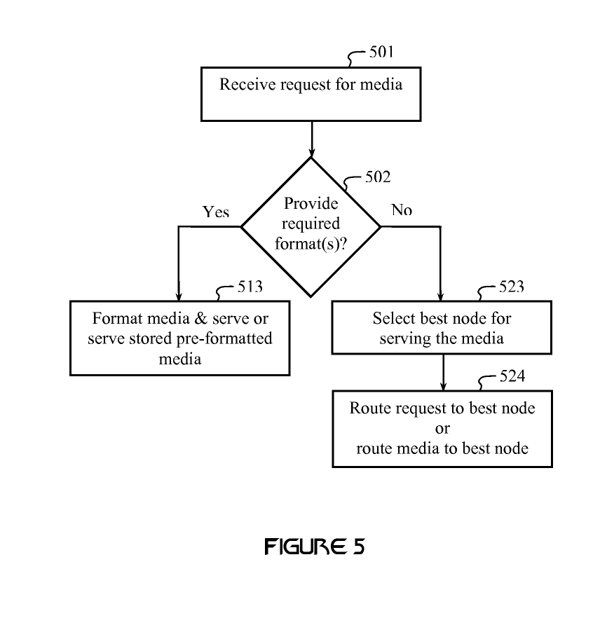

FIG. 5 is a flow diagram of a request routing method according to some aspects of the invention. A network node (e.g., node 122) receives a client's request for media 501. The node 122 determines if it can deliver the requested media in an optimal format 502. If the node 122 can deliver the requested media with the appropriate format, it formats and serves the media, or it delivers preformatted media stored in memory 513. If the node 122 is unable to deliver the requested media with the appropriate format, it identifies another node (e.g., node 123) in its virtual network that can provide the appropriately formatted media 523. The node 122 may forward the request to node 123, or node 122 may send the requested media to node 123 for formatting or reformatting 524 before delivery to the requesting client.

In accordance with some aspects of the invention, a request-routing system directs a client request to an optimal edge server, wherein “optimal” refers to the edge server that is both closest to the requesting client and capable of serving the requested media having a format that is most suitable for ingestion by the client. One or more servers use information about the client device, such as device information from a client database, to determine which format(s) is (are) suitable. Multiple edge servers may cooperate to direct a request and may use dynamic information about network loads and server queue backlogs when directing requests, formatting media, and serving media. The request-routing system interacts with the distribution system to convey the demand for content, which the distribution system uses to place suitably formatted content at the edge servers.

In Step 501, an edge server (e.g., node 122) receives the request for media directly from a client or from another server (e.g., node 121) that forwards the request from the client. In one aspect of the invention, information about the client may be included in the request, particularly if the request is forwarded from another server. The client information is used to identify the client device for determining the suitable media format for the client device. In another aspect, the suitable format accompanies the request for media. For example, the client or an intervening node may include format information with the request. In some aspects of the invention, node 122 may decide to deliver media having a different format than the format requested. Such changes to the suitable format may be made based on network loads and server queue backlogs.

In Step 502, the node 122 determines if it can deliver the requested media with the suitable format. The ability of the node 122 to deliver suitably formatted media typically depends on the node's 122 transcoding capability and/or whether the suitably formatted media is stored in the node's 122 memory. The node's 122 decision in Step 502 may also depend on a combination of factors, such as network congestion and demand for the node's 122 resources. Thus, even if node 122 is capable of serving the suitably formatted media, it may select 523 a different node (e.g., node 123) to serve the client, such as to improve network efficiency and/or better serve the client.

When selecting the best node (e.g., node 123) for serving the suitably formatted media to the client 523, “best” usually refers to the node that is capable of serving the client with the least amount of delay or best quality of service. When determining the best node, the total delay may comprise the time for processing the request (which may include transcoding the media) plus the time to deliver the requested media over the network. In the case where a first node has the suitably formatted media in memory, but is farther away from the client than a second node that needs to transcode the media, the first node may be selected as the best node.

In Step 524, the best mode for delivering the suitably formatted media to the client may be performed. For example, the request for media may be forwarded to the best node determined in Step 523. In one aspect, media from node 122 is routed 524 to the best node for transcoding before delivery. The transcoded media may be delivered directly to the requesting client or it may be returned to node 122, which then delivers the transcoded media.

Although the flow diagrams may describe operations as a sequential process, many of the operations can be performed in parallel or concurrently. In addition, the order of the operations may be re-arranged. A process is terminated when its operations are completed, but could have additional steps not included in the figures. A process may correspond to a method, a function, a procedure, a subroutine, a subprogram, etc. When a process corresponds to a function, its termination corresponds to a return of the function to the calling function or the main function.

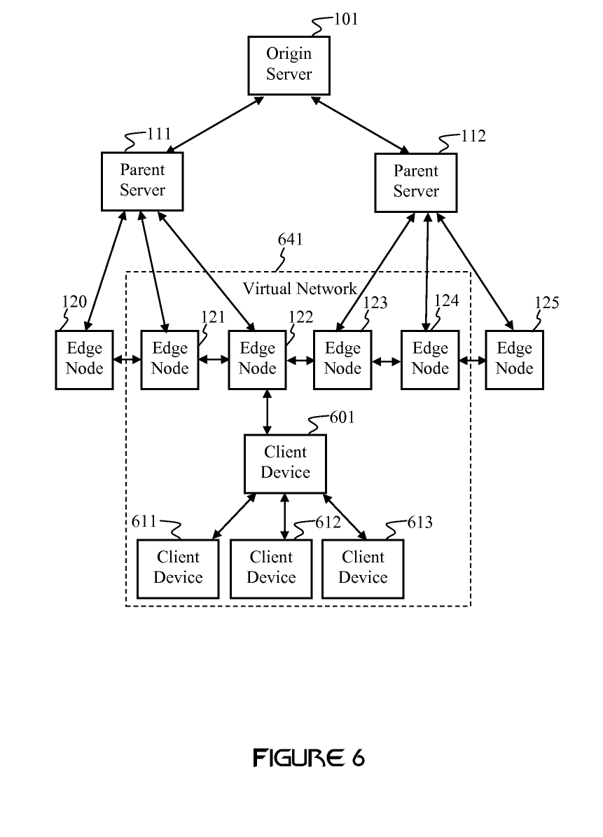

FIG. 6 is a network topology diagram of a CDN according to an aspect of the invention. A top-level cache comprises one or more origin servers, such as origin server 101. A mid-level cache comprises multiple parent servers, such as servers 111 and 112 communicatively coupled to the origin server 101. A bottom-level cache comprises multiple edge servers, such as edge nodes 120-125. Typically, each edge node 120-125 is communicatively coupled to at least one of the parent servers 111 and 112. Each edge node 120-125 typically serves one or more clients. For example, client 601 may be served by edge node 122.

In accordance with one aspect of the invention, client 601 and edge node 122 jointly establish a virtual network 641 with other client devices 611-613 and other edge nodes (e.g., nodes 121, 123, and 124). Optionally, one or more of the parent servers 111 and 112 and/or origin servers (e.g., origin server 101) may be part of the virtual network 141.

In one aspect, the virtual network 641 is managed by node 122, which allows the client 601 (and optionally, clients 611-613) to view and access resources on the other nodes 121, 123, and 124. In some aspects, certain properties about the network 641 and/or the nodes 121, 123, and 124 may be hidden from the client 601. For example, certain resources on the nodes 121-124 may be hidden from the client 601 if the client 601 does not have sufficient authorization. The layout of the virtual network 641 may be hidden from the client 601, and services offered by the other nodes 121, 123, and 124 may be represented to the client 601 without any indication as to which nodes offer those services.

In some aspects of the invention, the other client devices 611-613 are visible to at least one of the nodes (e.g., node 122). Node 122 may employ client device information about one or more of the clients 601 and 611-613 to serve suitably formatted media to client 601. In some aspects, clients 611-613 may view and access services offered by nodes 121-124 through client 601.

In one aspect of the invention, a method for requesting media in a CDN comprises communicating device information from a destination client (e.g., one of the clients 611-613) to a requesting client 601. The requesting client 601 configures its request for media from a CDN based on the device information of the destination client 611, 612, or 613, wherein the request for media specifies a media format suitable for ingestion by the destination client 611, 612, or 613. In some aspects, the request further comprises subscription authorization information from the destination client.

In another aspect of the invention, one of the destination clients 611-613 request media from the CDN via client 601. Node 122 identifies the destination client 611, 612, or 613, determines its device type, and delivers the requested media to client 601 that is suitably formatted for the destination client 611, 612, or 613.

The Figures are conceptual illustrations allowing for an explanation of the present invention. It should be understood that various aspects of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant arts.

1. A content delivery network (CDN), comprising:
an edge node of the CDN configured for establishing a virtual network overlaid on a network of geographically distributed content delivery nodes, the virtual network comprising a subset of the content delivery nodes in the CDN; and
a virtual network controller residing on the edge node configured for selecting the subset to provide complementary formatting resources, and routing requested media to at least one of the subset to produce suitably formatted media for delivery to a requesting client.

2. The CDN recited in claim 1, further comprising a request routing mechanism configured to intercept and evaluate a client request en-route to a server and modify the request, if necessary, to specify formatting that ensures the requested media is suitable for ingestion at the requesting client.

3. The CDN recited in claim 1, further comprising a distribution mechanism configured to intercept media en-route to the requesting client, and to format the media to produce a media format that is suitable for ingestion by the requesting client.

4. The CDN recited in claim 1, wherein the subset is selected to provide at least a minimum predetermined level of service to a requesting client.

5. The CDN recited in claim 1, wherein at least one of the edge node and at least one of the subset serves suitably formatted media to the requesting client.

6. The CDN recited in claim 1, wherein the complementary formatting resources are determined based on load-balancing algorithms that may serve to reduce network congestion.

7. The CDN recited in claim 1, wherein the edge node selects the subset based on queue backlogs at CDN servers.

8. The CDN recited in claim 1, wherein the virtual network controller reconfigures the virtual network based on changing network conditions.

9. The CDN recited in claim 1, wherein the virtual network controller employs client device information comprising at least one of presentation capabilities, operating system, software, and link bandwidth to determine a suitable format for the requested media

10. A method performed at an edge node in a content delivery network (CDN), comprising:
acquiring information about formatting capabilities of other CDN nodes;
determining which of the other CDN nodes can provide complementary formatting;
determining a distance to each of the other CDN nodes that can provide complementary formatting; and
selecting a set of the other CDN nodes to include in a virtual network based on each node's distance and its ability to provide complementary formatting.

11. The method recited in claim 10, wherein acquiring information comprises at least one of querying the other CDN nodes for their formatting capabilities, accessing a database comprising formatting capabilities of the other CDN nodes, and determining availability of the other CDN nodes to provide formatting.

12. The method recited in claim 10, wherein determining which of the other CDN nodes can provide complementary formatting comprises determining which formats are required based on client devices being served by the edge node.

13. The method recited in claim 10, wherein determining the distance comprises determining at least one of a transit time to deliver data between the edge node and a complementary node, a formatting time for the complementary node to format media, a retrieving time for the complementary node to retrieve formatted media, and a delivery time for the complementary node to deliver media to at least one client device served by the edge node.

14. The method recited in claim 10, wherein selecting comprises providing for redundancy when selecting nodes capable of providing complementary formatting.

15. The method recited in claim 10, further comprising at least one of pushing formatted media to at least one complementary node and pulling formatted media from at least one complementary node.

16. A request routing method performed at an edge node, comprising:
receiving a client request for media;
determining a most suitable format for requested media to be delivered to the client;
determining if the edge node can deliver requested media in the most suitable format;
upon determining that the edge node is unable to produce the requested media in the most suitable format, selecting at least one other node in a virtual network that can provide the most suitable format;
forwarding at least one of the request and the requested media to the at least one other node to provide for formatting the requested media; and
providing for delivery of the requested media in the most suitable format to the client.

17. The method recited in claim 16, wherein selecting comprises selecting an edge server that is both closest to the client and capable of serving the requested media in the most suitable format.

18. The method recited in claim 16, wherein selecting is based on at least one of network load and server queue backlog for each of a plurality of the at least one other node.

19. The method recited in claim 16, wherein determining the most suitable format comprises determining a different format than a requested format in the client request for media.

20. The method recited in claim 16, wherein providing for delivery of the requested media comprises at least one of delivering the requested media from the at least one other node to the client and returning suitably formatted media to the edge node.
